(19) United States
(12) Patent Application Publication
(10) Pub. No.: US 2016/0121484 A1
(43) Pub. Date: May 5, 2016

(54) CONTROL DEVICE WITH FUNCTION TO CHECK LOAD INFORMATION SETTINGS

(71) Applicant: FANUC Corporation, Yamanashi (JP)

(72) Inventors: Yu IKEDA, Yamanashi (JP); Hiromitsu TAKAHASHI, Yamanashi (JP); Soichi ARITA, Yamanashi (JP)

(21) Appl. No.: 14/918,602

(22) Filed: Oct. 21, 2015

(30) Foreign Application Priority Data
Oct. 29, 2014 (JP) 2014-220508

(51) Int. Cl. B25J 9/16; B25J 9/12

(52) U.S. Cl. CPC B25J 9/1633; B25J 9/12; B25J 9/1674; Y10S 901/09

(57) ABSTRACT

A control device includes an estimated torque calculation unit, an actual torque calculation unit, a torque comparison unit, and a stop unit. The estimated torque calculation unit calculates an estimated torque for maintaining the posture of an automatic machine based on preset load information when the machine is in a resting state in which its posture is maintained by a torque applied by a servomotor. The actual torque calculation unit calculates an actual torque actually applied to maintain the posture. The torque comparison unit compares an error between the estimated and actual torques with a predetermined first threshold. The stop unit stops subsequent operations of the automatic machine when the error is greater than the first threshold.

### BACKGROUND OF THE INVENTION

1. Field of the Invention

The present invention relates to a control device configured to control an industrial machine such as a robot or a machine tool.

2. Description of the Related Art

In industrial machines, such as robots or machine tools, which are driven by servomotors, feedforward control is widely employed to reduce tracking delay. In order to properly perform the feedforward control, it is necessary to accurately determine the dynamic characteristics of a target object to be controlled. Hence, when the robot or the machine tool carries an additional object, such as a machining tool or a workpiece, it is necessary to obtain the mass, the position of center of gravity, and an inertia matrix (hereinafter referred to as “the load information”) of the object (hereinafter referred to as “the load”). In general, the load information is manually input by a user or obtained through an estimation function.

JP H09-091004 A discloses a control method for controlling a robot or machine tool having a plurality of axes driven by a servomotor, in which load weight parameters to be used for feedforward control are estimated. According to this known technique, a torque is measured with respect to a target axis under different conditions including known conditions, and a plurality of simultaneous equations representing the equilibrium of moments are solved, in order to obtain the load weight parameters.

JP 2011-235374 A discloses a load estimation method for estimating the weight and the position of center of gravity of a workpiece held by a robot. According to this known technique, the weight of the workpiece is estimated based on the difference between a torque command sent to a motor in disregard of the weight of the workpiece and an actual torque under influence of the workpiece.

The known technique described in JP H09-091004 A or JP 2011-235374 A is effective in setting unknown load information. However, when an automatic machine such as a robot or a machine tool is in operation, the tools may be exchanged, the workpiece may be held or released, or a plurality of types of workpieces may be randomly handled, so that the load may vary at any given time. Therefore, it may be necessary to change the load information as necessary in accordance with the load that may vary depending on the circumstances. If the load information is not appropriately set, intended control may not be performed, the mechanism part may be damaged, or the cycle time may be prolonged due to the automatic machine operating at an unnecessarily low speed. It is, therefore, necessary to check whether or not the load information is appropriately set.

JP 2005-088140 A discloses an object processing method for obtaining object processing information from an information server via a radio frequency identification or RFID tag attached to an object, and carrying out the process for the object based on the object processing information. According to this known technique, information that is unique to the object, such as its shape and weight, is stored in the RFID tag. Therefore, the load information of the object to be processed can be obtained as necessary.

However, the known technique described in JP 2005-088140 A requires an RFID tag to be attached to the object and additional elements, such as a tag reader and a server, to be installed, thereby leading to increased cost. Accordingly, there is a need for a control device capable of checking whether or not the load information is appropriately set in a simplified manner.

### SUMMARY OF THE INVENTION

According to a first aspect of the present invention, there is provided a control device configured to control an automatic machine having a plurality of axes, each of which is driven by a servomotor, based on preset load information, the control device comprising: an estimated torque calculation unit configured to calculate an estimated torque of the servomotor for maintaining a posture of the automatic machine based on the load information when the automatic machine is in a resting state in which the posture of the automatic machine is maintained by a torque applied by the servomotor; an actual torque calculation unit configured to calculate an actual torque actually applied by the servomotor to maintain the posture; a torque comparison unit configured to compare an error between the estimated torque and the actual torque with a predetermined first threshold; and a stop unit configured to stop a subsequent operation of the automatic machine when the error is greater than the first threshold.

According to a second aspect of the present invention, in the control device according to the first aspect, the torque comparison unit is configured to compare the error with a predetermined second threshold, and the control device further comprises a notification unit configured to send a comparison result between the error and the second threshold.

According to a third aspect of the present invention, in the control device according to the first or second aspect, the actual torque calculation unit is configured to calculate the actual torque based on a feedback current of the servomotor and a torque constant of the servomotor.

According to a fourth aspect of the present invention, in the control device according to the first or second aspect, the actual torque calculation unit is configured to calculate the actual torque based on a measurement result obtained by a torque sensor attached to the automatic machine.

According to a fifth aspect of the present invention, in the control device according to any one of the first to fourth aspects, the estimated torque calculation unit is configured to correct the estimated torque based on a static friction torque obtained by calculating a torque for maintaining a posture of the automatic machine when no load is applied to the automatic machine or a known load is applied to the automatic machine.

According to a sixth aspect of the present invention, in the control device according to any one of the first to fifth aspects, the first threshold is set in accordance with a magnitude of the estimated torque.

According to a seventh aspect of the present invention, in the control device according to the second aspect, the second threshold is set in accordance with a magnitude of the estimated torque.

According to an eighth aspect of the present invention, in the control device according to any one of the first to seventh aspects, the first threshold is set based on a variation in torque for maintaining a posture of the automatic machine when no load is applied to the automatic machine or a known load is applied to the automatic machine.

According to a ninth aspect of the present invention, in the control device according to the second aspect, the second threshold is set based on a variation in torque for maintaining a posture of the automatic machine when no load is applied to the automatic machine or a known load is applied to the automatic machine.

According to a tenth aspect of the present invention, there is provided a control device configured to control an automatic machine having a plurality of axes, each of which is driven by a servomotor, based on preset load information, the control device comprising:

an estimated torque calculation unit configured to calculate an estimated torque of the servomotor for maintaining a posture of the automatic machine based on the load information when the automatic machine is in a resting state in which the posture of the automatic machine is maintained by a torque applied by the servomotor;

an actual torque calculation unit configured to calculate an actual torque actually applied by the servomotor to maintain the posture;

a torque comparison unit configured to compare an error between the estimated torque and the actual torque with a predetermined threshold; and

a notification unit configured to notify a user that the load information is inappropriate when the error is greater than the threshold.

These and other objects, features and advantages of the present invention will become more apparent in light of the detailed description of exemplary embodiments thereof as illustrated in the drawings.

### BRIEF DESCRIPTION OF THE DRAWINGS

FIG. 1 shows an exemplary configuration of a robot system to which the present invention can apply;

FIG. 2 is a block diagram illustrating functions of a control device according to one embodiment;

FIG. 3 is a flowchart illustrating a sequence of processes executed by the control device according to the embodiment;

FIG. 4 is a block diagram illustrating functions of a control device according to another embodiment; and

FIG. 5 is a block diagram illustrating functions of a control device according to still another embodiment.

### DETAILED DESCRIPTION

Embodiments of the present invention will be described below with reference to the accompanying drawings. The same reference numerals are used for the same or corresponding components.

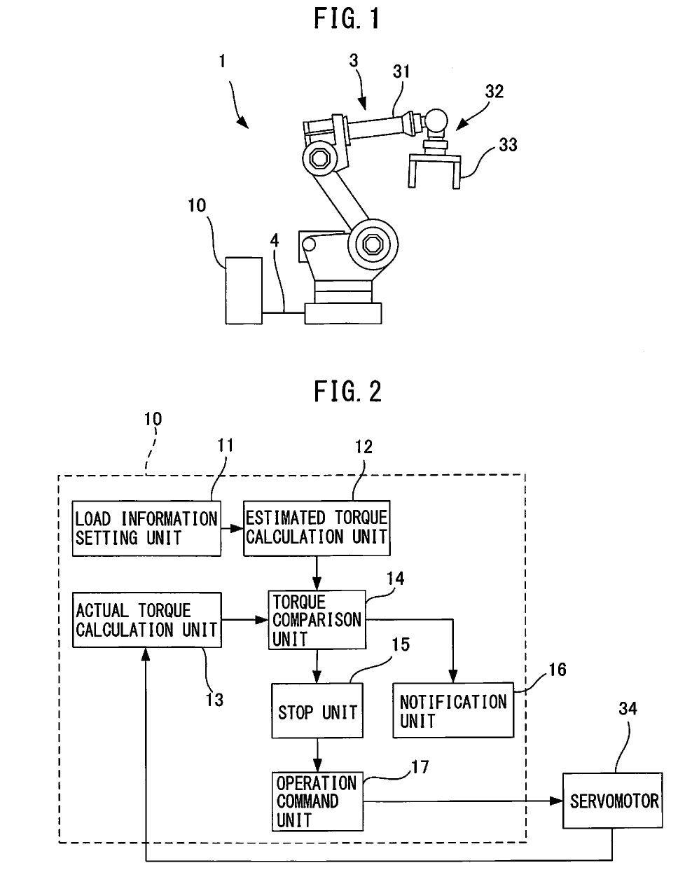

FIG. 1 shows an exemplary configuration of a robot system to which the present invention can apply. A robot system 1 includes a robot 3 and a control device 10 which controls the robot 3. The robot 3 includes a wrist 32 provided at a tip end of an arm 31. The wrist 32 is equipped with a tool such as a hand 33 used to hold a workpiece, which is not illustrated. The tool can be exchanged as necessary in accordance with a required process and may be various tools such as a welding gun, a paint gun, and a cutting edge of a machine tool. The robot 3 has any known configuration. For example, the robot 3 is a six-axis vertical articulated robot, as depicted in FIG. 1. The present invention may apply to any automatic machine having a plurality of axes driven by servomotors.

The control device 10 is connected to the robot 3 via a known communication means, for example, through a communication cable 4. The control device 10 transmits control commands to servomotors which drive the joint axes of the robot 3 to control the position and posture of the robot 3. The control device 10 has a known hardware configuration including a CPU, a RAM, a ROM, and an interface used to send and receive signals and data to and from an external device such as an input device and a display device.

FIG. 2 is a block diagram illustrating functions of the control device 10 according to one embodiment. The control device 10 includes a load information setting unit 11, an estimated torque calculation unit 12, an actual torque calculation unit 13, a torque comparison unit 14, a stop unit 15, a notification unit 16, and an operation command unit 17.

The load information setting unit 11 sets load information associated with loads applied to the robot 3. The loads may include various tools attached to the wrist 32 of the robot 3, the hand 33 of the robot 3, or a combination of the hand 33 and a workpiece held by the hand 33. The load information may include load parameters such as mass, a position of center of gravity, and an inertia matrix of the load applied to the robot 3. The load information may be known information input by a user or obtained using a known estimation function (see, for example, JP H09-091004 A or JP 2011-235374 A). Different kinds of load information may be set and switched from one to another by a signal or a program. When the load information is set in the control device 10 in advance, the initial settings may be used as is.

The estimated torque calculation unit 12 calculates a torque necessary to maintain the posture of the robot 3 in a resting state, based on the load information set by the load information setting unit 11, the current posture of the robot 3, and the dynamic parameters of the mechanism part of the robot 3 (the torque will be hereinafter referred to as “the estimated torque”). The robot 3 at “rest,” or in a resting state, means that the posture of the robot 3 is temporarily maintained by a torque output from a servomotor 34 while an independent braking means such as a brake is not active. For example, the posture of the robot 3 may be calculated based on the result of measurement using a position detector provided with the servomotor 34, such as an encoder. The dynamic parameters of the mechanism part are known and can be set in advance. When an estimated torque is used in feedforward control, the estimated torque calculation unit 12 may use an estimated torque calculated for the feedforward control, instead of separately calculating an estimated torque.

The actual torque calculation unit 13 calculates a torque which is actually output to maintain the robot 3 in the resting state (the torque will be hereinafter referred to as “the actual torque”). The actual torque may be calculated in accordance with a known method, for example, based on a feedback current of the servomotor 34, a torque constant of the servomotor 34 and the dynamic parameters of the mechanism part. The torque constant varies depending on the circumstances and therefore may be adjusted as necessary based on separately obtained temperature information. Alternatively, the actual torque may be calculated based on a torque command to the servomotor 34. In this manner, the operational information of the servomotor 34 or the command to the servomotor 34 may be used to eliminate a need for a separate sensor, thus keeping the cost low. However, in another embodiment, the actual torque calculation unit 13 may be configured to calculate an actual torque based on the measurement result obtained by a torque sensor attached to an output unit of the servomotor 34. This is advantageous in that the actual torque can be accurately obtained without the influence of the torque constant.

The operation command unit 17 generates a control command for operating the servomotor 34 of the robot 3. When the estimated torque calculation unit 12 and the actual torque calculation unit 13 calculate an estimated torque and an actual torque, respectively, the operation command unit 17 generates a command to the servomotor 34 so that the robot 3 is in the resting state. The command to bring the robot 3 to rest may correspond to the estimated torque calculated by the estimated torque calculation unit 12. In another embodiment, a torque which is output in response to a command to bring the robot 3 to rest, which is generated by the operation command unit 17, may be input to the torque comparison unit 14 as an estimated torque. In this case, the operation command unit 17 also functions as the estimated torque calculation unit 12.

The torque comparison unit 14 calculates an error between the estimated torque calculated by the estimated torque calculation unit 12 and the actual torque calculated by the actual torque calculation unit 13. Further, the torque comparison unit 14 compares the error between the torques with a predetermined first threshold. When the error is greater than the first threshold, the torque comparison unit 14 determines that the load information set by the load information setting unit 11 is inappropriate. When the error is equal to or smaller than the threshold, the torque comparison unit 14 determines that the current load information is appropriate. The error between the torques may be compared with the threshold based on the respective absolute values. Different thresholds in magnitude may be used for the comparison with the torque error, depending on whether the torque error has a positive or negative value. In order to ensure that a correspondence between the estimated torque and the actual torque is maintained to make the comparison, when one of the estimated and actual torques is a torque output from a speed reducer, the other torque is also calculated in consideration of the speed reduction ratio and transmission efficiency of the speed reducer.

The stop unit 15 outputs a signal to the operation command unit 17 to stop the robot 3 when the torque comparison unit 14 determines that the load information is inappropriate. In this case, scheduled subsequent operations of the robot 3 are canceled. The stoppage of the robot 3 is canceled upon a predetermined operation by a user, for example.

The notification unit 16 notifies the user of the comparison result obtained by the torque comparison unit 14. The comparison result may be displayed, for example, in the form of text or symbol or the like on a display device connected to the control device 10. Alternatively, the comparison result may be notified to a user in a perceivable manner, for example, by switching on a lamp, generating an alarm sound, or transmitting a signal to an external device.

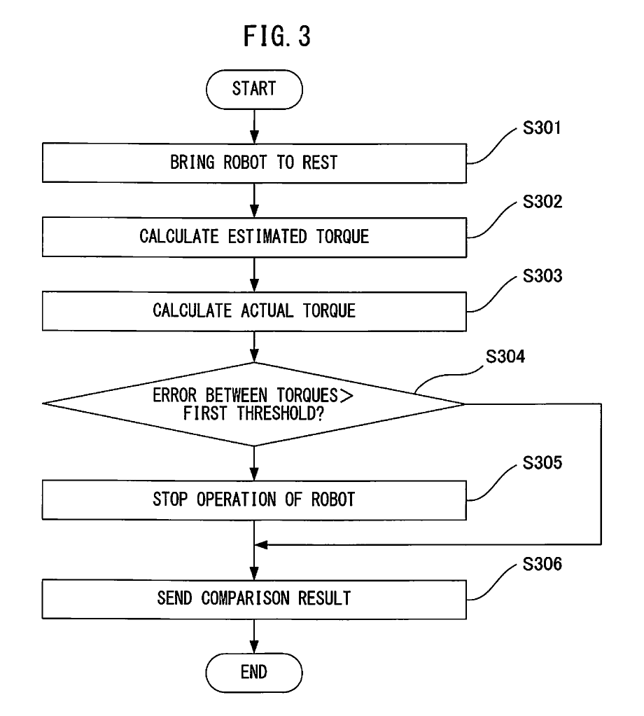

FIG. 3 is a flowchart illustrating a sequence of processes executed by the control device 10 according to the embodiment. The process to be described below with reference to FIG. 3 is a process for determining whether or not the load information set by the load information setting unit 11 is appropriate. Such a determining process may be executed, for example, every time a command is issued to bring the robot 3 to rest, or in accordance with a program, in response to an external signal, or upon the user's operation.

In step S301, the operation command unit 17 generates a stop command to bring the robot 3 to rest. The command issued in step S301 may include a position command by which an amount of movement of the robot 3 is zero or a speed command by which the speed of the robot 3 is zero. When the robot 3 is still in motion, for example, due to gravity even after the input of the command to rest, the position or speed is fed back as necessary and errors are accumulated as an integral term. The robot 3 eventually comes to rest.

When the robot 3 is in a resting state, the process advances to step S302, in which the estimated torque calculation unit 12 calculates an estimated torque, for example, based on the load information set by the load information setting unit 11, the current position and posture of the robot 3, the dynamic parameters of the mechanism part of the robot 3, and so on.

In step S303, the actual torque calculation unit 13 calculates an actual torque, i.e., a torque which is actually output in order to maintain the posture of the robot 3.

In step S304, the torque comparison unit 14 compares the error between the estimated torque and the actual torque with a predetermined first threshold. When it is determined in step S304 that the error between the torques is equal to or smaller than the first threshold, the load information set by the load information setting unit 11 is determined to be appropriate, and the process advances to step S306, which may be omitted as necessary. In step S306, the notification unit 16 notifies the user that the load information is appropriate. When the process for determining the load information is complete, the robot 3 executes scheduled subsequent operations.

On the other hand, when it is determined in step S304 that the error between the torques is greater than the first threshold, the load information is determined to be inappropriate, and the process advances to step S305. In step S305, the stop unit 15 outputs a stop signal to stop the robot 3. As a result, subsequent operations by the robot 3 are canceled. In step S306, which may be omitted as necessary, the notification unit 16 notifies the user that the load information is inappropriate.

When the employed load information does not reflect the load actually applied, the robot might operate at acceleration greater than that available for the safe operation, thus possibly damaging the mechanism part. Alternatively, when the employed load information corresponds to the load greater than the actual load, the robot 3 might operate at excessively low speed, resulting in increased cycle time and decreases of the productivity. In addition, when the control device 10 has a function to detect contact or noncontact with an external object based on the load information, the detection may not be properly implemented. However, the control device according to the present embodiment can automatically determine whether or not the load information used to control the robot 3 is set appropriately, and stop the robot 3, if necessary. This can prevent the above-mentioned various problems resulting from the inappropriate load information.

According to a variant of the above-mentioned embodiment, the torque comparison unit 14 of the control device 10 is further configured to compare the error between the estimated torque and the actual torque with a second threshold smaller than the first threshold. When the error between the torques is greater than the second threshold and smaller than the first threshold, the notification unit 16 notifies the user that the load information may be inappropriate. When the error between the torques is greater than the first threshold, the stop unit 15 stops the robot 3 and cancels scheduled subsequent operations by the robot 3, as described above. The second threshold may be set so as to notify the user that the robot 3 can be avoided from being damaged, but may not operate as desired.

As described above, according to this variant, when the load information is inappropriate, the robot 3 is stopped or a notification is sent to the user, depending on the extent to which the difference between the load information and the actual load. The torque error may be compared with the second threshold by comparing their absolute values with each other, as in the comparison with the first threshold, or by using the second threshold which varies depending on whether the torque errors is positive or negative.

In another variant, the stop unit 15 may be configured to be selectively disabled. Alternatively, the control device 10 may not include the stop unit 15. In this case, the user is notified by the notification unit 16 when the load information is inappropriate, whereas the robot 3 may not be stopped automatically. The control device 10 having such a configuration is advantageous in applications in which the robot 3 is preferably kept in operation.

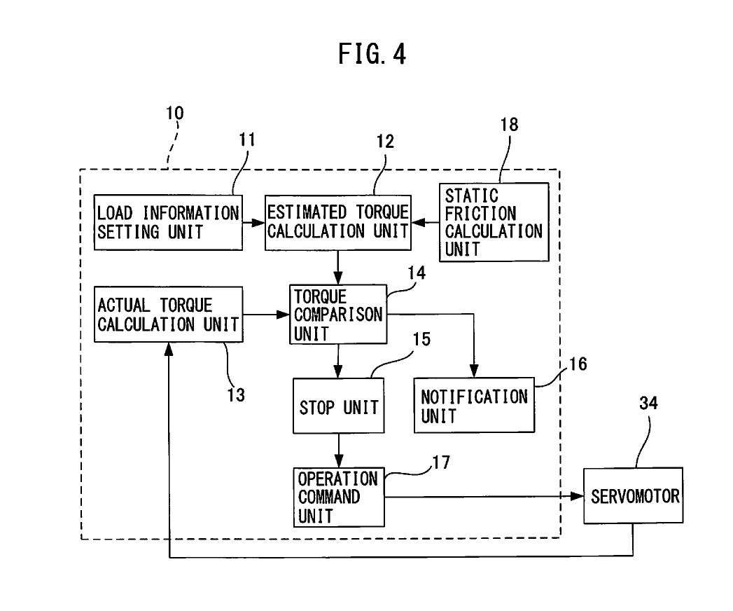

FIG. 4 is a block diagram illustrating functions of a control device 10 according to another embodiment. According to the present embodiment, the control device 10 further includes a static friction calculation unit 18.

The static friction calculation unit 18 calculates an error between an actual torque and an estimated torque under known conditions, as a static friction torque. The static friction torque is calculated before the determination process of the load information set by the load information setting unit 11. Specifically, the static friction torque can be obtained by calculating an error between an estimated torque obtained from the load information and an actual torque necessary to maintain the posture of a robot in a resting state when a known load is applied or a no load is applied, or in other words, when the accurate load information is ensured. The static friction torque obtained by the static friction calculation unit 18 is used to correct an estimated torque calculated by an estimated torque calculation unit 12. Therefore, according to the present embodiment, the estimated torque calculation unit 12 calculates an estimated torque in consideration of the static friction torque which is unique to the mechanism part of the robot 3, and therefore allows a more accurate estimated torque to be obtained.

The static friction torque is preferably calculated by the static friction calculation unit 18 under different known load conditions or at different positions and postures of the robot 3. This allows a more reliable static friction torque to be obtained.

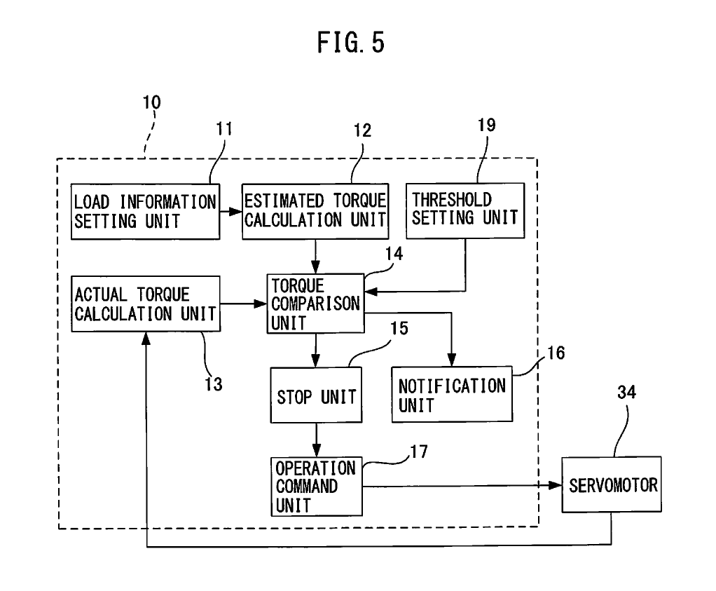

FIG. 5 is a block diagram illustrating functions of a control device 10 according to still another embodiment. In this embodiment, the control device 10 further includes a threshold setting unit 19. According to the present embodiment, at least one of the first and second thresholds used by the torque comparison unit 14 is corrected in consideration of an error between an estimated torque and an actual torque when the load information is accurate.

When a known load is applied or a no load is applied, or in other words, when the accurate load information is ensured, an error between an estimated torque obtained from the load information and an actual torque necessary to actually maintain the posture of the robot in a resting state is calculated. The threshold setting unit 19 sets the first or second threshold in accordance with the error between the torques. For example, even if the load information is accurate, when the error between the torques is large, the threshold setting unit 19 sets a relatively large threshold. In contrast, when the error between the torques is small, the threshold setting unit 19 sets a relatively small threshold. In this way, more accurate determination can be executed by setting the first or second threshold in consideration of variations in torque unique to the robot 3.

In still another embodiment, the threshold setting unit 19 sets a first or second threshold used in a comparison process by the torque comparison unit 14, in accordance with the magnitude of an estimated torque calculated by an estimated torque calculation unit 12. For example, when the magnitude of the estimated torque is large, i.e., the load is heavy, a relatively large threshold may be set in order to avoid erroneous determination. In this case, the threshold setting unit 19 is configured to appropriately set the first or second threshold in accordance with a predetermined relationship between the threshold and an estimated torque value. The threshold set by the threshold setting unit 19 may increase stepwise as estimated torque becomes larger. Alternatively, the threshold setting unit 19 may set a threshold that increases at a constant rate as estimated torque becomes larger.

### EFFECT OF THE INVENTION

The control device according to the present invention compares an estimated torque necessary to maintain the posture of an automatic machine, which is calculated based on preset load information, with an actual torque which is actually output to maintain the posture, and automatically determines whether or not the load information is appropriate based on the comparison result. The control device is configured to stop the machine or notify the user of an abnormality when the load information is determined to be inappropriate. This can prevent the machine from malfunctioning or the mechanism part from being damaged, due to the inappropriate load information.

Although various embodiments and variants of the present invention have been described above, it is apparent for a person skilled in the art that the intended functions and effects can also be realized by other embodiments and variants. In particular, it is possible to omit or replace a constituent element of the embodiments and variants, or additionally provide a known means, without departing from the scope of the present invention. Further, it is apparent for a person skilled in the art that the present invention can be implemented by any combination of features of the embodiments either explicitly or implicitly disclosed herein.

What is claimed is:

1. A control device configured to control an automatic machine having a plurality of axes, each of which is driven by a servomotor, based on preset load information, the control device comprising:
an estimated torque calculation unit configured to calculate an estimated torque of the servomotor for maintaining a posture of the automatic machine based on the load information when the automatic machine is in a resting state in which the posture of the automatic machine is maintained by a torque applied by the servomotor;
an actual torque calculation unit configured to calculate an actual torque actually applied by the servomotor to maintain the posture;
a torque comparison unit configured to compare an error between the estimated torque and the actual torque with a predetermined first threshold; and
a stop unit configured to stop a subsequent operation of the automatic machine when the error is greater than the first threshold.

2. The control device according to claim 1, wherein the torque comparison unit is configured to compare the error with a predetermined second threshold, and the control device further comprises a notification unit configured to send a comparison result between the error and the second threshold.

3. The control device according to claim 1, wherein the actual torque calculation unit is configured to calculate the actual torque based on a feedback current of the servomotor and a torque constant of the servomotor.

4. The control device according to claim 1, wherein the actual torque calculation unit is configured to calculate the actual torque based on a measurement result obtained by a torque sensor attached to the automatic machine.

5. The control device according to claim 1, wherein the estimated torque calculation unit is configured to correct the estimated torque based on a static friction torque obtained by calculating a torque for maintaining a posture of the automatic machine when no load is applied to the automatic machine or a known load is applied to the automatic machine.

6. The control device according to claim 1, wherein the first threshold is set in accordance with a magnitude of the estimated torque.

7. The control device according to claim 2, wherein the second threshold is set in accordance with a magnitude of the estimated torque.

8. The control device according to claim 1, wherein the first threshold is set based on a variation in torque for maintaining a posture of the automatic machine when no load is applied to the automatic machine or a known load is applied to the automatic machine.

9. The control device according to claim 2, wherein the second threshold is set based on a variation in torque for maintaining a posture of the automatic machine when no load is applied to the automatic machine or a known load is applied to the automatic machine.

10. A control device configured to control an automatic machine having a plurality of axes, each of which is driven by a servomotor, based on preset load information, the control device comprising:
an estimated torque calculation unit configured to calculate an estimated torque of the servomotor for maintaining a posture of the automatic machine based on the load information when the automatic machine is in a resting state in which the posture of the automatic machine is maintained by a torque applied by the servomotor;
an actual torque calculation unit configured to calculate an actual torque actually applied by the servomotor to maintain the posture;
a torque comparison unit configured to compare an error between the estimated torque and the actual torque with a predetermined threshold; and
a notification unit configured to notify a user that the load information is inappropriate when the error is greater than the threshold.
